(19) United States
(12) Patent Application Publication
(10) Pub. No.: US 2015/0118567 A1
(43) Pub. Date: Apr. 30, 2015

(54) SILICON CARBON COMPOSITE CATHODE MATERIAL AND PREPARATION METHOD THEREOF, AND LITHIUM-ION BATTERY

(71) Applicant: Huawei Technologies Co., Ltd., Shenzhen (CN)

(72) Inventor: Wei Chen, Shenzhen (CN)

(21) Appl. No.: 14/587,689

(22) Filed: Dec. 31, 2014

Related U.S. Application Data
(63) Continuation of application No. PCT/CN2013/070456, filed on Jan. 15, 2013.

(30) Foreign Application Priority Data
Aug. 28, 2012 (CN) 201210309860.4

(51) Int. Cl. H01M 4/36; H01M 10/0525; H01M 4/38

(52) U.S. Cl. CPC H01M 4/366; H01M 4/386; H01M 10/0525; H01M 2220/30
USPC 429/231.8; 427/122

(57) ABSTRACT

A silicon carbon composite cathode material includes a graphite particle, further includes a silicon or silicon-containing particle, and includes a porous carbon layer, where the silicon or silicon-containing particle is distributed in vicinity of the graphite particle, the porous carbon layer coats a surface of the graphite particle and the silicon or silicon-containing particle so as to combine the graphite particle and the silicon or silicon-containing particle together, the porous carbon layer is a low crystalline carbon layer or an amorphous carbon layer, an interlayer distance d(002) of the low crystalline carbon layer is ≧3.45 nm, and a size of the silicon or silicon-containing particle is smaller than a size of the graphite particle. The silicon carbon composite cathode material has a porous structure, a stable material structure, a high capacity, high conductivity performance, and good cycling performance.

### CROSS-REFERENCE TO RELATED APPLICATIONS

This application is a continuation of International Application No. PCT/CN2013/070456, filed on Jan. 15, 2013, which claims priority to Chinese Patent Application No. 201210309860.4, filed on Aug. 28, 2012, both of which are hereby incorporated by reference in their entireties.

### TECHNICAL FIELD

The present invention relates to the field of lithium-ion batteries, and in particular, to a silicon carbon composite cathode material, a preparation method thereof, and a lithium-ion battery.

### BACKGROUND

Due to advantages such as light mass, a small volume, a high working voltage, high energy density, large output power, a high charging efficiency, no memory effect, and a long cycle life, a lithium-ion battery has attracted close attention of people and found wide application in fields such as a mobile phone and a notebook computer.

Due to constant improvement in performance of a mobile device and a communications device in recent years, a higher requirement is raised for energy density, a cycle life, high-current input and output performance, and the like of a lithium-ion battery. A cathode material is a main body of lithium storage, and performance of the cathode material directly affects performance of the lithium-ion battery. Currently, a commercialized lithium-ion battery mainly uses graphitized carbon as the cathode material. However, because a theoretical specific capacity of graphite is relatively low (about 372 mAh/g), a specific capacity of the lithium-ion battery is relatively low. Moreover, lithium intercalation potential of the graphite cathode is close to lithium metal potential, lithium may be separated out on a surface during high-rate charging, which easily causes a safety issue. Therefore, development of a new-type high-capacity high-rate cathode material has very high value in research and use.

A silicon material becomes a focus of research due to its high specific capacity (4200 mAh/g and 9786 mAh/cm³) and relatively high lithium intercalation potential (about 0.4V). However, a process of lithium-ion intercalation and deintercalation of the silicon material comes with a severe volume change, which is about 320%. As a result, during a cyclical charging/discharging process, the silicon material pulverizes, which causes destruction of an electrical contact channel between adjacent particles. Therefore, a battery capacity rapidly decreases, and a lithium-ion battery has relatively poor cycling performance.

At present, a silicon carbon composite material is proposed to resolve a problem of relatively poor cycling performance of a silicon cathode. However, after relatively long charge-discharge cycling of the composite material, the cathode material is still destroyed due to periodic stress that is generated from a relatively large volume change of a silicon particle, which causes a gram specific capacity of the material to rapidly decrease and thereby shortens a cycle life of the battery.

### SUMMARY

In view of this, a first aspect of embodiments of the present invention provides a silicon carbon composite cathode material to resolve a problem that a capacity and cycling performance of a lithium-ion battery decrease because a battery cathode material structure is destroyed due to periodic stress that is generated from a relatively large volume change of silicon in an existing silicon carbon composite material. A second aspect of the embodiments of the present invention provides a method for preparing the silicon carbon composite cathode material. A third aspect of the embodiments of the present invention provides a lithium-ion battery.

According to the first aspect, an embodiment of the present invention provides the silicon carbon composite cathode material, where the silicon carbon composite cathode material includes a graphite particle, further includes a silicon or silicon-containing particle, and includes a porous carbon layer, where the silicon or silicon-containing particle is distributed in vicinity of the graphite particle, the porous carbon layer coats a surface of the graphite particle and the silicon or silicon-containing particle so as to combine the graphite particle and the silicon or silicon-containing particle together, the porous carbon layer is a low crystalline carbon layer or an amorphous carbon layer, an interlayer distance d(002) of the low crystalline carbon layer is ≧3.45 nm, and a size of the silicon or silicon-containing particle is smaller than a size of the graphite particle.

Compared with the prior art, the silicon carbon composite cathode material provided by this embodiment of the present invention includes the graphite particle, further includes the silicon or silicon-containing particle, and includes the porous carbon layer, where the porous carbon layer coats a surface of the graphite particle and the silicon or silicon-containing particle so as to combine the graphite particle and the silicon or silicon-containing particle together. That is, the silicon or silicon-containing particle is scattered in the porous carbon layer and distributed in vicinity of the graphite particle, where the vicinity means that the silicon or silicon-containing particle is in contact with or adjacent to the graphite particle. The porous carbon layer is the low crystalline carbon layer or the amorphous carbon layer, and the interlayer distance d(002) of the low crystalline carbon layer is ≧3.45 nm. Preferably, a porous aperture of the porous carbon layer is 2-100 nm. More preferably, the porous aperture of the porous carbon layer is 2-20 nm. A porous structure of a carbon layer can provide space for a volume change of the cathode material, mitigate the periodic stress that is generated from a volume change of the silicon or silicon-containing particle during a cyclical charging/discharging process, prevent material pulverization and collapse, and increase material structure stability, thereby improving the cycling performance of the cathode material. In addition, the porous structure of the carbon layer may also absorb and accommodate electrolyte, so as to perform rapid electrolyte conduction and reduce polarization of a battery, thereby improving rate performance of the battery and implementing rapid charging and discharging.

The graphite particle is selected from one or more of artificial graphite, natural graphite, and a mesocarbon microbead. The silicon-containing particle is a particle of a silicon compound and a silicon-containing composite particle. Specifically, the silicon compound is silicon oxide, and the silicon-containing composite particle is a silicon-containing heterogeneous material, silicon alloy, or a silicon material that has a conductive carbon coating layer. More specifically, the silicon-containing heterogeneous material is formed by an amorphous electrochemical active phase (silicon-containing) and electrochemical inactive phase (a silicon-containing intermetallic compound, a solid solution, or a mixture of the silicon-containing intermetallic compound and the solid solution), and the electrochemical active phase is scattered in the electrochemical inactive phase.

In the silicon carbon composite cathode material provided by this embodiment of the present invention, in the silicon or silicon-containing particle, a weight percentage of silicon in the silicon carbon composite cathode material is 0.1-50%. A weight ratio of the silicon or silicon-containing particle, the graphite particle, and the porous carbon layer is 0.1-35:35-99.8:0.1-30. The silicon has a relatively high specific capacity; however, conductivity performance of the silicon is poorer than graphite, and a porous layer of enough mass can provide sufficient volume change space for the cathode material. Therefore, when the silicon is used to increase a capacity of the cathode material, an appropriate content ratio of each component can ensure relatively high conductivity performance of the cathode material and implement effective suppression on a phenomenon that the cathode material structure is destroyed due to the periodic stress that is generated from a volume change of the silicon.

In the silicon carbon composite cathode material provided by this embodiment of the present invention, a particle diameter of the silicon or silicon-containing particle is less than a particle diameter of the graphite particle. Therefore, the silicon or silicon-containing particle may be better and evenly distributed in the porous carbon layer and be adhesive to the surface of the graphite particle. Preferably, the particle diameter of the graphite particle is 1-40 μm, and the particle diameter of the silicon or silicon-containing particle is 0.03-2 μm. More preferably, the particle diameter of the silicon or silicon-containing particle is 0.03-0.5 μm. The graphite particle and the silicon or silicon-containing particle are combined together by using the porous carbon layer. Preferably, a thickness of the porous carbon layer is 0.03-5 μm. An appropriate carbon layer thickness can ensure that the surface of the graphite particle and the silicon or silicon-containing particle is completely coated by the porous carbon layer, so as to prevent separation between the graphite particle and the silicon or silicon-containing particle. An excessively large carbon layer thickness increases an intercalation path of a lithium-ion and is bad for rapid charging and discharging.

A silicon carbon composite cathode material provided by the first aspect of the embodiments of the present invention has a porous structure, a stable material structure, a high capacity, high conductivity performance, and good cycling performance.

According to the second aspect, an embodiment of the present invention provides the method for preparing the foregoing silicon carbon composite cathode material, where the method includes the following steps:

(1) dissolving amphiphilic surfactant in a carbon precursor solution and stirring obtained solution evenly to obtain a carbon precursor solution including surfactant;

(2) getting a graphite particle and a silicon or silicon-containing particle, adding the particles into the carbon precursor solution including surfactant, stirring obtained solution evenly, and then drying the solution; and

(3) roasting the foregoing dried product at 900-1400° C. under protection of an inert gas, so that the carbon precursor is carbonized and the surfactant is resolved to form a porous carbon layer and eventually obtain the silicon carbon composite cathode material of a porous structure.

A block type high-molecular polymer surfactant is selected and used as the amphiphilic surfactant in step (1).

Preferably, the amphiphilic surfactant is polyisoprene-b-poly(ethylene oxide) (PI-b-PEO), poly(ethylene glycol)-b-polyacrylonitrile (PEO-b-PAN), or (EO)ₗ(PO)ₘ-(EO)ₙ, where 1, m, and n are 5-200 .

The high-molecular surfactant is dissolved in the carbon precursor solution to form an even mixed solution. The surfactant and the carbon precursor perform sufficient self-assembly at a molecular level. After the surfactant is resolved at a high temperature, multiple holes that are evenly distributed are formed in a carbon layer, thereby avoiding a problem of material pulverization and collapse caused by occurrence of excessively large local periodic stress during a cyclical charging/discharging process. This increases material structure stability and thereby improves cycling performance of the cathode material. A size of a porous aperture may be controlled by using molecular weight and addition amount of the surfactant.

Preferably, the carbon precursor is polyvinyl alcohol or phenol formaldehyde resin. A solvent of the carbon precursor solution is preferably ethyl alcohol, propyl alcohol, isopropyl alcohol, or acetone.

Related description of the graphite particle and the silicon or silicon-containing particle in step (2) is the same as that described above, which is not repeatedly described herein. A mass ratio of the surfactant, the carbon precursor, the silicon or silicon-containing particle, and the graphite particle is 0.1-40:0.1-40:0.1-35:35-99.8.

Preferably, a temperature for the drying is 90-105° C. and drying duration is 12-24 hour.

In step (3), the carbon precursor is carbonized during a process of high-temperature roasting at 900-1400° C., and the surfactant is resolved and emits a large amount of gas, thereby forming the porous carbon layer. This porous carbon layer is a low crystalline carbon layer or an amorphous carbon layer, and has a porous structure with evenly distributed holes. An interlayer distance d(002) of the low crystalline carbon layer is ≧3.45 nm. Preferably, a porous aperture of the porous carbon layer is 2-100 nm. More preferably, the porous aperture of the porous carbon layer is 2-20 nm. Preferably, a thickness of the porous carbon layer is 0.03-5 μm. Preferably, the inert gas is one or more of nitrogen, argon, and helium. Preferably, roasting duration is 1-10 hours. A porous structure of a carbon layer can provide space for a volume change of the cathode material, mitigate the periodic stress that is generated from a volume change of the silicon or silicon-containing particle during a cyclical charging/discharging process, prevent material pulverization and collapse, and increase material structure stability, thereby improving the cycling performance of the cathode material. In addition, the porous structure of the carbon layer may also absorb and accommodate electrolyte, so as to perform rapid electrolyte conduction and reduce polarization of a battery, thereby improving rate performance of the battery and implementing rapid charging and discharging.

The second aspect of the embodiments of the present invention provides a method for preparing the silicon carbon composite cathode material. A technology is easy, and mass production is easily implemented. The silicon carbon composite cathode material that is obtained by preparation by using this method has a porous structure, a stable material structure, a high capacity, high conductivity performance, and good cycling performance.

The third aspect of the embodiments of the present invention provides the lithium-ion battery that includes the foregoing silicon carbon composite cathode material.

The lithium-ion battery provided by the third aspect of the embodiments of the present invention has a high capacity, good cycling performance, and rapid charging and discharging performance.

Advantages of the embodiments of the present invention are partially described in the following specification, a part of which is apparent according to the specification, or may be learned by means of implementation of the embodiments of the present invention.

### DETAILED DESCRIPTION

The following is exemplary implementation manners of embodiments of the present invention. It should be noted by a person of ordinary skill in the art that various improvements and modifications may be further made without departing from the principles of the embodiments of the present invention and should be construed as falling within the protection scope of the embodiments of the present invention.

A first aspect of embodiments of the present invention provides a silicon carbon composite cathode material to resolve a problem that a capacity and cycling performance of a lithium-ion battery decrease because a battery cathode material structure is destroyed due to periodic stress that is generated from a relatively large volume change of silicon in an existing silicon carbon composite material . A second aspect of the embodiments of the present invention provides a method for preparing the silicon carbon composite cathode material. A third aspect of the embodiments of the present invention provides a lithium-ion battery.

According to the first aspect, an embodiment of the present invention provides the silicon carbon composite cathode material, where the silicon carbon composite cathode material includes a graphite particle, further includes a silicon or silicon-containing particle, and includes a porous carbon layer, where the silicon or silicon-containing particle is distributed in vicinity of the graphite particle, the porous carbon layer coats a surface of the graphite particle and the silicon or silicon-containing particle so as to combine the graphite particle and the silicon or silicon-containing particle together, the porous carbon layer is a low crystalline carbon layer or an amorphous carbon layer, an interlayer distance d(002) of the low crystalline carbon layer is ≧3.45 nm, and a size of the silicon or silicon-containing particle is smaller than a size of the graphite particle.

Compared with the prior art, the silicon carbon composite cathode material provided by this embodiment of the present invention includes the graphite particle, further includes the silicon or silicon-containing particle, and includes the porous carbon layer, where the porous carbon layer coats a surface of the graphite particle and the silicon or silicon-containing particle so as to combine the graphite particle and the silicon or silicon-containing particle together. That is, the silicon or silicon-containing particle is scattered in the porous carbon layer and distributed in vicinity of the graphite particle, where the vicinity means that the silicon or silicon-containing particle is in contact with or adjacent to the graphite particle. The porous carbon layer is the low crystalline carbon layer or the amorphous carbon layer, and the interlayer distance d(002) of the low crystalline carbon layer is ≧3.45 nm. A porous aperture of the porous carbon layer is 2-100 nm. In this implementation manner, the porous aperture of the porous carbon layer is 2-20 nm. A porous structure of a carbon layer can provide space for a volume change of the cathode material, mitigate the periodic stress that is generated from a volume change of the silicon or silicon-containing particle during a cyclical charging/discharging process, prevent material pulverization and collapse, and increase material structure stability, thereby improving the cycling performance of the cathode material. In addition, the porous structure of the carbon layer may also absorb and accommodate electrolyte, so as to perform rapid electrolyte conduction and reduce polarization of a battery, thereby improving rate performance of the battery and implementing rapid charging and discharging.

The graphite particle is selected from one or more of artificial graphite, natural graphite, and a mesocarbon microbead. The silicon-containing particle is a particle of a silicon compound and a silicon-containing composite particle. Specifically, the silicon compound is silicon oxide, and the silicon-containing composite particle is a silicon-containing heterogeneous material, silicon alloy, or a silicon material that has a conductive carbon coating layer. More specifically, the silicon heterogeneous material is formed by an amorphous electrochemical active phase (silicon-containing) and electrochemical inactive phase (a silicon-containing intermetallic compound, a solid solution, or a mixture of the silicon-containing intermetallic compound and the solid solution), and the electrochemical active phase is scattered in the electrochemical inactive phase.

In the silicon carbon composite cathode material provided by this embodiment of the present invention, in the silicon or silicon-containing particle, a weight percentage of silicon in the silicon carbon composite cathode material is 0.1-50%. A weight ratio of the silicon or silicon-containing particle, the graphite particle, and the porous carbon layer is 0.1-35:35-99.8:0.1-30. The silicon has a relatively high specific capacity; however, conductivity performance of the silicon is poorer than graphite, and a porous layer of enough mass can provide sufficient volume change space for the cathode material. Therefore, when the silicon is used to increase a capacity of the cathode material, an appropriate content ratio of each component can ensure relatively high conductivity performance of the cathode material and implement effective suppression on a phenomenon that the cathode material structure is destroyed due to the periodic stress that is generated from a volume change of the silicon.

In the silicon carbon composite cathode material provided by this embodiment of the present invention, a particle diameter of the silicon or silicon-containing particle is less than a particle diameter of the graphite particle. Therefore, the silicon or silicon-containing particle maybe better and evenly distributed in the porous carbon layer and be adhesive to the surface of the graphite particle. The particle diameter of the graphite particle is 1-40 μm, and the particle diameter of the silicon or silicon-containing particle is 0.03-2 μm. In this implementation manner, the particle diameter of the silicon or silicon-containing particle is 0.03-0.5μm. The graphite particle and the silicon or silicon-containing particle are combined together by using the porous carbon layer. A thickness of the porous carbon layer is 0.03-5 μm. An appropriate carbon layer thickness can ensure that the surface of the graphite particle and the silicon or silicon-containing particle is completely coated by the porous carbon layer, so as to prevent separation between the graphite particle and the silicon or silicon-containing particle. An excessively large carbon layer thickness increases an intercalation path of a lithium-ion and is bad for rapid charging and discharging.

A silicon carbon composite cathode material provided by the first aspect of the embodiments of the present invention has a high capacity, high conductivity performance, a stable structure, and good cycling performance.

According to the second aspect, an embodiment of the present invention provides the method for preparing the foregoing silicon carbon composite cathode material, where the method includes the following steps:

(1) dissolving amphiphilic surfactant in a carbon precursor solution and stirring obtained solution evenly to obtain a carbon precursor solution including surfactant;

(2) getting a graphite particle and a silicon or silicon-containing particle, adding the particles into the carbon precursor solution including surfactant, stirring obtained solution evenly, and then drying the solution; and

(3) roasting the foregoing dried product at 900-1400° C. under protection of an inert gas, so that the carbon precursor is carbonized and the surfactant is resolved to form a porous carbon layer and eventually obtain the silicon carbon composite cathode material of a porous structure.

A block type high-molecular polymer surfactant is selected and used as the amphiphilic surfactant in step (1).

The amphiphilic surfactant is polyisoprene-b-poly(ethylene oxide) (PI-b-PEO), poly(ethylene glycol)-b-polyacrylonitrile (PEO-b-PAN), or (EO)ₗ-(PO)ₘ-(EO)ₙ, where 1, m, and n are 5-200. In this implementation manner, the (EO)ₗ-(PO)ₘ-(EO)ₙ is (EO)₁₀₆-(PO)₇₀-(EO)₁₀₆.

The high-molecular surfactant is dissolved in the carbon precursor solution to form an even mixed solution. The surfactant and the carbon precursor perform sufficient self-assembly at a molecular level. After the surfactant is resolved at a high temperature, multiple holes that are evenly distributed are formed in a carbon layer, thereby avoiding a problem of material pulverization and collapse caused by occurrence of excessively large local periodic stress during a cyclical charging/discharging process. This increases material structure stability and thereby improves cycling performance of the cathode material. A size of a porous aperture may be controlled by using molecular weight and addition amount of the surfactant.

The carbon precursor may be polyvinyl alcohol or phenol formaldehyde resin. In this implementation manner, the carbon precursor is phenol formaldehyde resin. A solvent of the carbon precursor solution may be ethyl alcohol, propyl alcohol, isopropyl alcohol, or acetone. In this implementation manner, the solvent of the carbon precursor solution is ethyl alcohol . A source of the phenol formaldehyde resin is not limited. The phenol formaldehyde resin may be obtained by reaction between phenol or resorcinol and formaldehyde or acetaldehyde under an alkaline condition. In this implementation manner, the phenol formaldehyde resin is obtained by reaction between the phenol and the formaldehyde under the alkaline condition.

Related description of the graphite particle and the silicon or silicon-containing particle in step (2) is the same as that described above, which is not repeatedly described herein. A mass ratio of the surfactant, the carbon precursor, the silicon or silicon-containing particle, and the graphite particle is 0.1-40:0.1-40:0.1-35:35-99.8.

A temperature for the drying is 90-105° C. and drying duration is 12-24 hour.

In step (3), the carbon precursor is carbonized during a process of high-temperature roasting at 900-1400° C., and the surfactant is resolved and emits a large amount of gas, thereby forming the porous carbon layer. This porous carbon layer is a low crystalline carbon layer or an amorphous carbon layer, and has a porous structure with evenly distributed holes. An interlayer distance d(002) of the low crystalline carbon layer is ≧3.45 nm. A porous aperture of the porous carbon layer is 2-100 nm, and a thickness of the porous carbon layer is 0.03-5 μm. The inert gas may be one or more of nitrogen, argon, and helium. Roasting duration is 1-10 hours. A porous structure of a carbon layer can provide space for a volume change of the cathode material, mitigate the periodic stress that is generated from a volume change of the silicon or silicon-containing particle during a cyclical charging/discharging process, prevent material pulverization and collapse, and increase material structure stability, thereby improving the cycling performance of the cathode material. In addition, the porous structure of the carbon layer may also absorb and accommodate electrolyte, so as to perform rapid electrolyte conduction and reduce polarization of a battery, thereby improving rate performance of the battery and implementing rapid charging and discharging.

The second aspect of the embodiments of the present invention provides a method for preparing the silicon carbon composite cathode material. A technology is easy, and mass production is easily implemented. The silicon carbon composite cathode material that is obtained by preparation by using this method has a porous structure, a stable material structure, a high capacity, high conductivity performance, and good cycling performance.

The third aspect of the embodiments of the present invention provides the lithium-ion battery that includes the foregoing silicon carbon composite cathode material.

The lithium-ion battery provided by the third aspect of the embodiments of the present invention has a high capacity, good cycling performance, and rapid charging and discharging performance.

Embodiments of the present invention are further described below separately by using multiple embodiments. The embodiments of the present invention are not limited to the following specific embodiments. Proper modifications to the implementation without departing from the scope of the principal claims are allowed.

### Embodiment 1

A method for preparing a silicon carbon composite cathode material is as follows:

(1) Mix 0.6 g phenol, 0.15 g NaOH solution with a mass percentage of 20%, and 1.1 g formaldehyde solution with a mass percentage 37%, stir obtained solution at 70° C. for 1 hour, and then cool down the solution to a room temperature. Then, add 0.6 mol/L HCL solution to the foregoing mixed solution drop by drop until the solution is neutral, and then dry the solvent by evaporation under a vacuum condition to obtain a carbon precursor.

(2) Add the foregoing carbon precursor to 20.0 g ethyl alcohol, add 1.0 g surfactant (EO)₁₀₆-(PO)₇₀-(EO)₁₀₆ (Pluronic F127), and stir obtained solution evenly to obtain a carbon precursor solution including surfactant.

(3) Mix 0.1 g silicon composite particles with a particle diameter of 200 nm (a silicon cathode product that is produced by the 3M company and of which a model is L-20772), 0.5 g graphite particles with a particle diameter of 13 μm (Shanshan Technology, FSNC-1), and 4.0 g carbon precursor solution including surfactant together, stir obtained solution evenly, and then bake the foregoing mixture at 90° C. for 5 hour and at 105° C. for 24 hour separately.

(4) Roast the foregoing dried product at 900° C. for 1 hour under protection of nitrogen to obtain a silicon carbon composite cathode material that has an amorphous carbon layer or a low crystalline carbon layer and is of a porous structure.

A nitrogen adsorption test method is used to represent aperture distribution of the silicon carbon composite cathode material that is prepared in this embodiment, and an average aperture size obtained by testing is 2.5 nm.

A method for preparing a lithium-ion battery is as follows:

Mix the foregoing prepared silicon carbon composite cathode material and a conductive agent (Timcal, Super-p, and SFG-6) evenly, add 8% Pvdf (Arkmer, HSV900) solution (NMP is a solvent), stir obtained solution evenly to form a mixed slurry, evenly coat the obtained slurry on a copper current collector with a thickness of 10 μm, and bake the copper current collector at 110° C. under a vacuum condition for 12 h to obtain a cathode sheet, where super-p:SFG-6:Pvdf=92:3:1:4. Use lithium metal as a counter electrode, celgard C2400 as a membrane, 1.3 mol/L LiPG₆/EC+DEC (a volume ratio is 3:7) solution as electrolyte to assemble a 2016 model button battery along with the foregoing prepared cathode sheet.

### Embodiment 2

A difference between this embodiment and Embodiment 1 lies only in that the silicon composite particle with a particle diameter of 200 nm is replaced with a silicon nanoparticle with a particle diameter of 100 nm. A nitrogen adsorption test method is used to represent aperture distribution of the silicon carbon composite cathode material that is prepared in this embodiment, and an average aperture size obtained by testing is 2.5 nm.

### Embodiment 3

A difference between this embodiment and Embodiment 1 lies only in that the surfactant (EO)₁₀₆-(PO)₇₀-(EO)₁₀₆ (Pluronic F127) is replaced with polyisoprene-b-poly(ethylene oxide) (PI-b-PEO), where Mₙ of the polyisoprene-b-poly(ethylene oxide)=15640 g/mol, and a mass fraction of the PEO is 13.9%. A nitrogen adsorption test method is used to represent aperture distribution of the silicon carbon composite cathode material that is prepared in this embodiment, and an average aperture size obtained by testing is 17.4 nm.

### Embodiment 4

A difference between this embodiment and Embodiment 1 lies only in that the surfactant (EO)₁₀₆-(PO)₇₀-(EO)₁₀₆ (Pluronic F127) is replaced with polyisoprene-b-poly(ethylene oxide) (PI-b-PEO), where Mₙ of the polyisoprene-b-poly(ethylene oxide)=27220 g/mol, and a mass fraction of the PEO is 16.7%. A nitrogen adsorption test method is used to represent aperture distribution of the silicon carbon composite cathode material that is prepared in this embodiment, and an average aperture size obtained by testing is 8.2 nm.

### Comparison Example 1

A difference between this comparison example and Embodiment 1 lies only in that the surfactant (EO)₁₀₆-(PO)₇₀-(EO)₁₀₆ (Pluronic F127) is not added to a process of preparing a silicon carbon composite cathode material.

### Comparison Example 2

A difference between this comparison example and Embodiment 2 lies only in that the surfactant (EO)₁₀₆-(PO)₇₀-(EO)₁₀₆ (Pluronic F127) is not added to a process of preparing a silicon carbon composite cathode material.

A lithium-ion battery that is prepared in the foregoing embodiments and comparison examples is an experimental battery, and is used for a performance test in the following effect embodiment.

### Effect Embodiment

To provide strong support for a beneficial effect that is brought by technical solutions in the embodiments of the present invention, the following performance test is specifically provided:

A button battery that is prepared in the embodiments and comparison examples is charged at a current of a 100 mA/1 g active substance until a voltage is 0.001V; then the button battery is charged at a constant voltage until a current is less than that of a 10 mA/1 g active substance; wait for 10 mins; and the foregoing button battery is discharged at a current of a 100 mA/1 g active substance until the voltage of the button battery is 1.5V. The foregoing charging and discharging process that is implemented is recorded as one charging/discharging cycle.

Table 1 describes a discharging capacity, a charging capacity, and Coulombic efficiency in a first charging and discharging cycle, and a discharging capacity, a charging capacity, discharging efficiency, and a capacity retention rate in a 50th charging and discharging cycle of button batteries that are prepared in Embodiments 1 and 2 and Comparison examples 1 and 2.

TABLE 1

| | 1st Cycle | | | 50th Cycle | | | |
|---|---|---|---|---|---|---|---|
| | Discharging | Charging | Coulombic | Discharging | Charging | Discharging | Capacity |
| | Capacity | Capacity | Efficiency | Capacity | Capacity | Efficiency | Retention |
| | mAh/g | mAh/g | (%) | mAh/g | mAh/g | (%) | Rate (%) |
| Embodiment 1 | 678 | 1250 | 54 | 619 | 632 | 98 | 91 |
| Embodiment 2 | 723 | 1291 | 56 | 615 | 628 | 98 | 85 |
| Comparison | 790 | 1300 | 61 | 420 | 432 | 97 | 53 |
| example 1 | | | | | | | |
| Comparison | 680 | 1130 | 60 | 300 | 315 | 95 | 44 |
| example 2 | | | | | | | |

It may be learned from a result of Table 1 that, compared with the comparison examples, in Embodiments 1 and 2, because a surfactant is added, a porous carbon layer is formed in a silicon carbon composite cathode material. A porous structure provides space for a volume change of the cathode material, mitigates periodic stress that is generated from a volume change of silicon during a cyclical charging/discharging process, increases material structure stability, and thereby improves cycling performance of a battery. In addition, the porous structure of the carbon layer may also absorb and accommodate electrolyte, so as to perform rapid electrolyte conduction and reduce polarization of a battery, thereby improving rate performance of the battery and implementing rapid charging and discharging.

What is claimed is:

1. A silicon carbon composite cathode material, comprising:
a graphite particle, a silicon or silicon-containing particle, and a porous carbon layer;
wherein the silicon or silicon-containing particle is distributed in vicinity of the graphite particle, the porous carbon layer coats a surface of the graphite particle and the silicon or silicon-containing particle so as to combine the graphite particle and the silicon or silicon-containing particle together, the porous carbon layer is a low crystalline carbon layer or an amorphous carbon layer, an interlayer distance d(002) of the low crystalline carbon layer is greater than or equal to 3.45 nm, and a size of the silicon or silicon-containing particle is smaller than a size of the graphite particle.

2. The silicon carbon composite cathode material according to claim 1, wherein:
the graphite particle is one or more of artificial graphite, natural graphite, and a mesocarbon microbead; and
the silicon-containing particle is a silicon-containing heterogeneous material, silicon alloy, or silicon oxide.

3. The silicon carbon composite cathode material according to claim 1, wherein a porous aperture of the porous carbon layer is 2-100 nm, and a thickness of the porous carbon layer is 0.03-5 μm.

4. The silicon carbon composite cathode material according to claim 1, wherein a particle diameter of the silicon or silicon-containing particle is 0.03-2 μm, and a particle diameter of the graphite particle is 1-40 μm.

5. The silicon carbon composite cathode material according to claim 1, wherein a weight percentage of silicon in the silicon carbon composite cathode material is 0.1-50%.

6. The silicon carbon composite cathode material according to claim 1, wherein a weight ratio of the silicon or silicon-containing particle, the graphite particle, and the porous carbon layer is 0.1-35:35-99.8:0.1-30.

7. A method for preparing a silicon carbon composite cathode material, the method comprising:
dissolving amphiphilic surfactant in a carbon precursor solution and stirring evenly to obtain a carbon precursor solution including surfactant;
obtaining a graphite particle and a silicon or silicon-containing particle, adding the particles into the carbon precursor solution including surfactant, stirring evenly, and drying the solution; and
heating the foregoing dried product at 900-1400° C. under protection of an inert gas, so that a carbon precursor is carbonized and the surfactant is resolved to form a porous carbon layer and eventually obtain the silicon carbon composite cathode material of a porous structure.

8. The method for preparing a silicon carbon composite cathode material according to claim 7, wherein the surfactant is polyisoprene-b-poly(ethylene oxide), poly(ethylene glycol)-b-polyacrylonitrile, or (EO)ₗ-(PO)ₘ-(EO)ₙ, wherein 1, m, and n are 5-200.

9. The method for preparing a silicon carbon composite cathode material according to claim 7, wherein a mass ratio of the surfactant, the carbon precursor, the silicon or silicon-containing particle, and the graphite particle is 0.1-40:0.1-40:0.1-35:35-99.8.

10. A lithium-ion battery, comprising:
the silicon carbon composite cathode material according to claim 1.
